(19) United States
(12) Patent Application Publication
(10) Pub. No.: US 2003/0136158 A1
(43) Pub. Date: Jul. 24, 2003

(54) AUTOMOBILE ACCESSORY LOCK

(76) Inventor: Minas Minasian, Pasadena, CA (US)

Correspondence Address: Charles R. Sutton, 14507 Sylvan St., Ste. 208, Van Nuys, CA, 91411, US

(21) Appl. No.: 10/055,559

(22) Filed: Jan. 22, 2002

(51) Int. Cl. E05B 73/00

(52) U.S. Cl. 70/14

(57) ABSTRACT

A locking mechanism having a box with a hinged lid in which the box and hinged lid form a circular aperture between them when the lid is closed. The box has an anchoring flange attached which is used to anchor the box to the chassis of a vehicle. The box is anchored and the lid then closed with the aperture around the end of the bar which must be lifted before the third seat can be removed from a sport utility vehicle. Integral with the box is a locking mechanism consisting of a curved bar which holds the lid shut and a turning lock stop. The curved bar removably penetrates the box and has a groove cut across the portion of the bar which fits through the box. The turning lock stop can be moved into a position in which it prevents turning or removal of the curved bar. The turning lock stop can be turned only by means of a key or secret combination.

### CROSS-REFERENCES TO RELATED APPLICATIONS There are no related applications.

### STATEMENT AS TO RIGHTS TO INVENTIONS MADE UNDER FEDERALLY-SPONSORED RESEARCH AND DEVELOPMENT

This invention was not made under Federally Sponsored Research and Development. The inventor retains all rights.

### BACKGROUND OF THE INVENTION

1. Field of the Invention

This invention falls within the category of automotive locks and more narrowly, locks to prevent the theft of automobile accessories.

2. Description of Related Art Including Information Disclosed Under 37 CFR Section 1.97 and 1.98.

Automotive locks have been made successfully for years which prevent theft of the automobile by means of the lock obstructing operation. THE CLUB is a popular lock which obstructs operation of the steering wheel by anyone who does not have a key to the lock. Other devices exist which will disconnect a pole of the battery and deny access to the engine compartment and there are even devices known by which the steering wheel can be removed entirely. Common devices to prevent the theft of accessories include devices to prevent removal of trailers or trailer hitches, and devices to prevent removal of car stereos. The devices to prevent removal of car stereos often feature a set of bars in which the stereo is held and which are, in turn, secured to the chassis at a point inaccessible to the thief.

### SUMMARY OF THE INVENTION

This invention is a specialized lock for automobile accessories, especially bench seats, which makes it impossible to remove them without a key. It does so by obstructing operation of the bar which must be lifted in order to remove the accessory. The theft of the rear seats from popular models of sport utility vehicles is rampant. It costs hundreds of dollars to replace such a seat. This lock fits over one end of a bar under the seat and obstructs the bar from being slid out of the lock's socket. A hooked flange of the lock secures the lock to the auto chassis at a point inaccessible to the would be thief. The lock cannot be removed from its position without a key. The seat cannot be removed unless the lock is removed. Therefore, only a person with a key to the lock can slide the seat bar from its socket to remove the seat.

### BRIEF DESCRIPTION OF THE DRAWINGS

FIG. 1 depicts the invention fully assembled and locked.

FIG. 2 depicts the locking bar removed from the lock.

FIG. 3 depicts the lock in an open state with locking bar removed and interior space shown.

FIG. 4 depicts a vehicle seat with its release bar mechanism.

### DESCRIPTION OF THE PREFERRED EMBODIMENT

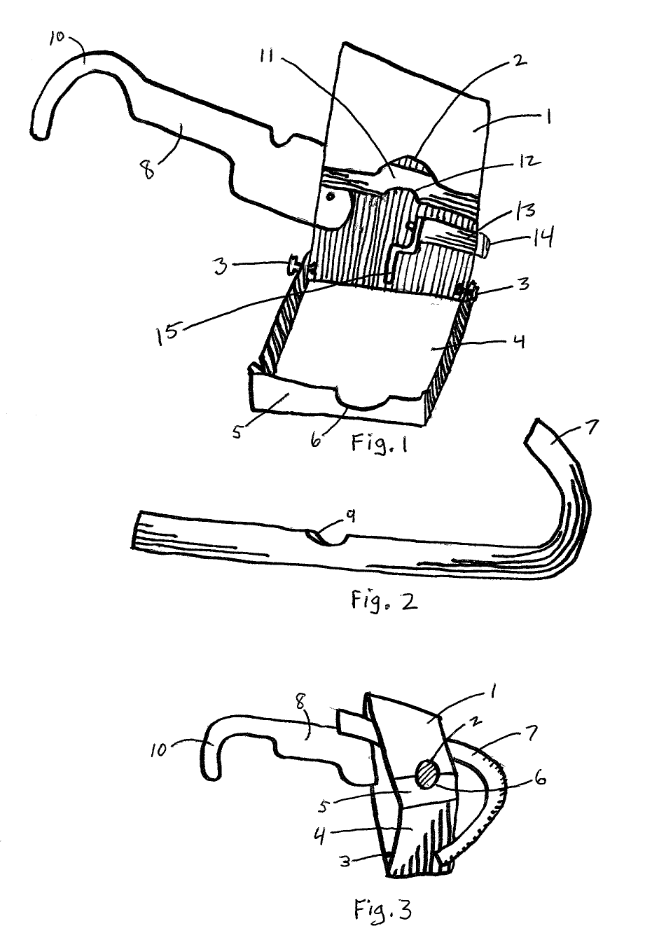

The preferred embodiment of this invention comprises a box (1) having five substantially rigid quadrangular sides. One of the five sides is a quadrangle which is fixedly joined to the other four sides so that each of its four sides is joined to a different one of the other four quadrangles. Each of its four sides, in fact, is coextensive with one of the four sides of the particular quadrangle with which it is joined. A fixed method of joining is used to produce a dihedral between the two sides that is approximately a 90 degree angle. When four sides are joined to the fifth in this way, each of the four sides joined to the fifth also has two other neighboring sides which have edges coextensive with two of its own. These edges are also joined fixedly to produce a rigid cube like structure with one side being an opening. Four of the five rigid sides each have an edge which is part of the open quadrangle that is the sixth face of the cube like structure. In each case, this edge is the only edge of that particular quadrangle that is not joined to one of the other four rigid quadrangles. Referring now to FIG. 1 it can be seen that one of the four quadrangles with one of these unjoined edges has a box cutaway (2) in the edge which is substantially semicircular. Near each unjoined edge of the open quadrangle which is adjacent to the edge with the box cutaway (2) is a rivet (3) penetrating the rigid quadrangle which bears that edge at a point proximal to the unjoined edge which is opposite to the edge bearing the box cutaway (2). A substantially rigid lid (4) is swingably mounted to the box (1) by means of these rivets (3). The lid (4) has a fold (5) which overlaps the quadrangle bearing the box cutaway (2) when the lid (4) is closed. The fold (5) has a lid cutaway (6) which is substantially semicircular and which is situated so that it forms a substantially circular aperture with the box cutaway (2) when the lid (4) is closed. A locking bar (7) seen in FIG. 2 penetrates two of the rigid quadrangles of the box so that it can prevent the lid (4) from being opened. An anchoring flange (8) is connected to one of the rigid quadrangles so that it can be anchored to the automobile chassis in a place inaccessible to a would be thief. When this attachment is done the lock cannot be removed from its position, at least not without a key. Referring now to FIG. 2, the locking bar (7) is shown removed from the lock. It is a substantially cylindrical rigid rod that has curvature at one end. On the portion of the locking bar (7) which is not curved is a groove (9) cut transversely to the axis of the locking bar (7). Referring now to FIG. 3, the lock is shown opened and with the locking bar removed. The anchoring flange (8) can be seen to have a hook (10) at the end distal to the point where the anchoring flange (8) is attached to the box (1). The hook would fit into a slot cut into the metal of the car chassis or would hook through a metal loop welded onto the chassis. Hooked in this way the box cannot be removed without reorienting the box in a way made impossible by the presence of the car seat and the chassis. Therefore, the lock must be unlocked so the box can be reoriented or the seat removed before it will be possible to remove the hook from its anchored position. A tube (11) penetrates the interior of the box (1) communicating between the two apertures on quadrangle sides through which the locking bar (7) ordinarily penetrates. The locking bar (7) slides through the hollow bore of the tube (11). A tube cutaway (12) transects the wall of the tube. The tube cutaway (12) is positioned so that when the locking bar is in the tube (11) and turned so that its curved portion overlays the closed lid (4), the groove (9) is aligned with the tube cutaway (12) and appears therethrough. One of the rigid quadrangles of the box (1) has a lock body (13) attached so that the lock body (13) is inside the box (1), but the lock body presents a key slot (14) or alphanumeric combination to the outside of the box (1). The lock body (13) has a lock stop (15) which moves as the lock body (13) is operated from outside the box (1). In the locked position, the lock stop (15) fits into the groove (9) through the tube cutaway (12) and thereby prevents the locking bar (7) from being turned away from the lid (4) or removed from the box (1). The lock stop (15) must be turned away from the groove (9) using a key or combination before the locking bar (7) can be turned or removed. Unless the locking bar is turned or removed, the lid (4) cannot be opened.

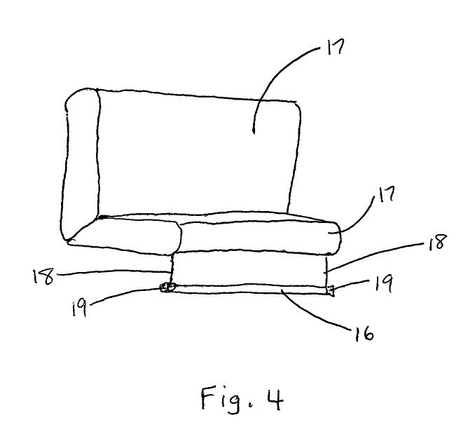

Referring now to FIG. 4, the mechanism is ordinarily used by placing the anchoring flange at an appropriate anchoring site and then enclosing the aperture formed by the box and lid cutaways around the end of the seat bar (16) which must be lifted up in order to remove the third seat (17) from a sport utility vehicle. When the mechanism is locked in this position, the bar cannot be lifted and the seat cannot be removed. Ordinarily the seat bar (16) which is movably connected to the bottom of the third seat (17) by attachment braces (18), is attached to the attachment braces (18) by bolts (19). For the present invention to be properly theft resistant, it is optimal to provide aftermarket bolts adapted to be non-removable or the thief would bypass the invention by removing the seat bar (16) from the attachment braces (18) and then sliding the seat bar out of the aperture of the invention.

I claim:

1. In combination:
a box having three rigid polygonal sides denominated as side one, side two, and side three, and at least one open polygonal side;
said side one having a first edge that defines a first boundary line segment of said open polygonal side, said first edge having a first cutaway defining an indentation into said side one;
said side two having a second edge that defines a second boundary line segment of said open polygonal side, said side two sharing a third edge with said side one, said side two having forst means for attachment proximal to said second edge and distal to said third edge;
said side three having a fourth edge that defines a third boundary line segment of said open polygonal side, said side three sharing a fifth edge with said side one, said side three having second means for attachment proximal to said fourth edge and distal to said fifth edge;
an anchoring flange mounted to extend from at least one of said three rigid polygonal sides, said anchoring flange having anchoring means thereon at a point distal to said box;
a tube penetrating two of said three rigid polygonal sides, said tube being transected by a second cutaway;
a lock body fixedly attached to one of said three rigid polygonal sides so that it is inside of said box, said lock body having a lock stop movably attached at a point inside said box, said lock body presenting a means for controlled actuation of said lock stop outside of said box;
a rigid polygonal lid, said lid having a sixth edge, said lid having a fold fixedly attached to said sixth edge to form an angle with said lid, said fold having a third cutaway defining an indentation into said fold distal to said sixth edge;
a locking bar having a straight region and a curved region, said straight region adapted to fit axially through said tube, said straight region having a transverse groove, said transverse groove being exposed through said second cutaway when said locking bar is in said tube and when said curved region is oriented to overlap said open polygonal side;
said lid being swingably mounted to said first and said second means for attachment at points distal from said fold so that, when closed, said lid covers said open polygonal side and said fold overlaps said side one so that said third cutaway cooperates with said side one so that said third cutaway cooperates with said first cutaway to form an orifice;
said lock stop being movable by said actuator so that said lock stop engages said groove through said second cutaway to prevent said locking bar from being moved and to prevent saidlocking bar from being removed from said tube;
said hook engaging an immovable portion of a vehicle so that, when said box is closed with said orifice surrounding a release bar of a vehicle seat so that said vehicle seat cannot be removed unless said actuator is used to disengage said lock stop from said groove so that said locking bar can be turned so that said curved region does not overlap said lid; and
said actuator being operable only by selected individuals.

2. The invention of claim 1 in which said tube penetrates said side two and said side three.

3. The invention of claim 1 in which said actuator is operable by a key.

4. The invention of claim 3 in which said actuator is operable by a magnetic key.

5. The invention of claim 3 in which said actuator is operable by an electronic key.

6. The invention of claim 3 in which said actuator is operable by an electromagnetic key.

7. The invention of claim 1 in which said actuator is operable by an alphanumeric combination.

8. In combination:
a box having four rigid substantially quadrangular sides denominated as side one, side two, side three, and side four, and at least one open substantially quadrangular side;
said side one having a first edge that defines a first boundary line segment of said open substantially quadrangular side, said first edge having a first cutaway defining a substantially semicircular void region into side one;
said side two having a second edge that defines a second boundary line segment of said open substantially quadrangular side, said side two sharing a third edge with said side one, said side two having a first means for attachment proximal to said second edge and distal to said third edge;
said side three having a fourth edge that defines a third boundary line segment of said open substantially quadrangular side, said side three sharing a fifth edge with said side one, said side three having a second means for attachment proximal to said fourth edge and distal to said fifth edge;
an anchoring flange mounted to extend from at least one of said four rigid substantially quadrangular sides, said anchoring flange having a hook mounted thereon at a point distal to said box;
a tube penetrating two of said four rigid substantially quadrangular sides, said tube being transected by a second cutaway;
a lock body fixedly attached to one of said four rigid substantially quadrangular sides so that it is inside of said box, said lock body having a lock stop movably attached at a point inside said box, said lock body presenting a means for controlled actuation of said lock stop outside said box;
a rigid substantially quadrangular lid, said lid having a sixth edge, said lid having a fold fixedly attached to said sixth edge to form an angle with said lid of approximately ninety degrees, said fold having a substantially semicircular third cutaway distal to said sixth edge;
a locking bar having a straight region and a curved region, said straight region adapted to fit axially through said tube, said straight region having a transverse groove, said transverse groove being exposed through said second cutaway when said locking bar is in said tube and when said curved region is oriented to overlap said open substantially quadrangular side;
said lid being swingably mounted to said first and said second means for attachment at points distal from said fold so that, when closed, said lid covers said open substantially quadrangular side and said fold overlaps said side one so that said third cutaway cooperates with said first cutaway to form a substantially circular orifice;
said lock stop being movable by said actuator so that said lock stop engages said groove through said second cutaway to prevent said locking bar from being moved and to prevent said locking bar from being removed from said tube;
said hook engaging the chassis of a vehicle so that, when said box is closed with said substantially circular orifice surrounding a release bar of a vehicle seat, said vehicle seat cannot be removed unless said actuator is used to disengage said lock stop from said groove so that said locking bar can be turned so that said curved region does not overlap said lid; and
said actuator being usable only by selected individuals.

9. The invention of claim 8 in which said actuator is operable magnetically.

10. The invention of claim 8 in which said tube penetrates said side two and said side three.

11. The invention of claim 8 in which said actuator is operable by a key.

12. The invention of claim 11 in which said actuator is operable by a magnetic key.

13. The invention of claim 11 in which said actuator is operable by an electronic key.

14. The invention of claim 11 in which said actuator is operable by an electromagnetic key.

15. The invention of claim 8 in which said actuator is operable by an alphanumeric combination.
